(19) United States
(12) Patent Application Publication
(10) Pub. No.: US 2019/0019123 A1
(43) Pub. Date: Jan. 17, 2019

(54) SELF-SUSTAINABLE OBJECTS WITHIN DEPLOYABLE PROCESSES

(71) Applicant: SAP SE, Walldorf (DE)

(72) Inventor: Peter HAFFNER, St. Leon-Rot (DE)

(21) Appl. No.: 15/649,648

(22) Filed: Jul. 14, 2017

(51) Int. Cl. G06Q 10/06

(52) U.S. Cl. CPC G06Q 10/06311

(57) ABSTRACT

Various embodiments of systems and methods for executing a work process through self-sustainable objects are described herein. The method includes identifying a work process comprising a plurality of self-sustainable objects. A self-sustainable object includes data representing values of one or more attributes of the self-sustainable object. The self-sustainable object monitors its data. Based upon the monitored data, the self-sustainable determines or detects whether an event is triggered. One or more events may be predefined for the self-sustainable objects. When an event is triggered, the self-sustainable object executes an action including sending message to another self-sustainable object, sending a message to a user, initiating a repair action, and updating its status to one of an active state, an inactive state, etc. The self-sustainable object may request for user's input and the requested user's input may be provided to the self-sustainable object for executing the work process.

### BACKGROUND

“Deployable process” also termed as “work process” refers to a sequence of tasks or steps to produce a service or product. For example, a work process ‘article creation’ may comprise sequence of steps (e.g., article request created, goods receipt, dispatch, etc.) for procuring an article or a product. Using the work process ‘article creation’ a user, e.g., a store manager, can procure a product. The work process is required to be monitored for proper functioning of a task within an enterprise. Some work processes might be critical and may be required to be monitored continuously in real-time (e.g., flight tracking), while other, less critical work processes, may be required to be monitored periodically at regular time intervals (e.g., machine performance tracking, contract renewal, etc.). An error, fault, expiry, and/or failure at a step of the work process may be detected and notified so that a proper action may be initiated on time for successful execution of the tasks.

Usually, the work process is monitored manually and when an event occurs (e.g., in case of a failure), an action (e.g., recovery action) is initiated manually (e.g., by one or more users) which may be an error prone, costly, and an arduous task. Further, if there is a human error or negligence there may be a delay in initiating recovery action which may be dangerous for critical work processes such as flight tracking. Now-a-days, monitoring work processes, triggering events (e.g., in case of failure), and initiating actions may be automated for efficient execution of work processes. However, developing an application to automatically monitor a work process, trigger events, and initiate corresponding actions may be a time-consuming, costly, and arduous task. It may be required to determine various objects within the work process, analyze the behavior of the objects, and analyze the relationships between the objects, etc., to develop such application. Further, if any change is required within the work process (e.g., addition of new object, deletion of an object, editing an object, etc.), then the application may have to be modified (edited) accordingly. Moreover, until the application is modified, the monitoring of the updated work process might get interrupted and there might be delay in initiating recovery actions, which may put the execution of the tasks or work process at risk.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram illustrating work process comprising self-sustainable process steps and self-sustainable objects for automatic monitoring and control of the work process, according to an embodiment.

FIG. 2 is a block diagram illustrating structure of a self-sustainable object, according to an embodiment.

FIG. 3 is a block diagram illustrating a rule engine communicatively connected to the self-sustainable object to define or update events and rules for the self-sustainable object, according to an embodiment.

FIG. 4 is a block diagram illustrating an event repository including an event table storing various events defined for the self-sustainable objects of the work process, according to an embodiment.

FIG. 5 is a flowchart illustrating execution of work process through self-sustainable objects, according to an embodiment.

FIG. 6 is a block diagram illustrating an exemplary computer system, according to an embodiment.

### DESCRIPTION

Embodiments of techniques for self-sustainable objects within work processes are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”. “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

“Work process” refers to a sequence of tasks or steps to produce a service or product. For example, a work process ‘data mining’ may comprise sequence of steps (process steps) to fetch relevant or desired data. The work process ‘data mining’ may comprise sequence of steps including data retrieval, data filtering, and data clustering. The process step ‘data retrieval’ may be used to retrieve data from a data repository, the process step ‘data filtering’ may be used to filter the retrieved data (e.g., based upon some parameter such as product identifier or ID) and the process step ‘data clustering’ may be used to cluster (group) the filtered data into different groups or clusters. For example, in an embodiment, the process step ‘data retrieval’ may be configured to retrieve ‘employee attendance’ data from the data repository, the process step ‘data filtering’ may be configured to filter the retrieved ‘employee attendance’ data based upon a parameter (e.g., employee ID), and the process step ‘data clustering’ may be configured to cluster filtered data (attendance data of employee) based upon, e.g., day, month, etc. Another example of a work process may be ‘contract management’ which comprise sequence of steps (process steps) including contract creation and contract renewal for managing contracts. The process step “contract creation” may be used to create contract and the process step “contract renewal” may be used to renew the contract to enable continuous procurement of product or service. The process step “contract renewal” may comprise sub-process steps (a) request for quotation (RFQ) sent to a supplier to invite the supplier to bid on particular product or service (e.g., price per item or product (i.e., target price), timeframe or validity period for which the price quotation may be valid, and target quantity of product to be purchased within the specified timeframe); (b) receipt of quotation from the supplier; (c) generation of purchase request or purchase requisition (PR) to notify a purchasing department about the product it needs to order, the target quantity, and the timeframe for order fulfillment; and (d) creation of purchase order (PO) to buy the item or product. Alternately, the work process “contract management” may comprise process steps namely (i) contract creation; (ii) request for quotation (RFQ); (iii) receipt of quotation; (iv) generation of purchase request or purchase requisition (PR); and (v) creation of PO. Using the work process ‘contract management’ a user, e.g., a store manager, can manage contracts and can procure or buy a product from a supplier at a definite price for a specified timeframe. A process step (e.g., contract renewal) may be monitored regularly for proper functioning of a task. e.g., renewing the contract to continue procuring or buying the product from the supplier. An instance of the work process (e.g., contract management) may be created for managing specific contract and producing or procuring respective service or product. The “work process” may also be referred as “deployable process.”

“Object” refers to a logical unit or a software model (including logic and data) representing real-world or virtual entities. For example, an object may represent a document such as a sales order (SO), a purchase order (PO), an invoice, a product, a piece of equipment, etc. An object may have one or more attributes or parameters, e.g., the object PO may include parameters such as contract identifier (ID), supplier name, price, requested delivery date, and quantity, etc. Typically, an object comprises logic and/or data. The data refers to values of various parameters of the object. For example, for the object “contract” the data may be values of parameters contract ID, expiry date, validity period, quantity, price, etc. A process step or a sub-process step may involve one or more objects. In an embodiment, a process step or a sub-process step may be realized as an object. For example, the process step “generation of PR” may be realized as object “purchase requisition (PR)” which may include: (i) logic for generating PR; and (ii) data such as target price, timeframe or validity period, and target quantity.

“Self-sustainable object” refers to an object configured to monitor or examine itself (e.g., monitor or examine its data) and trigger or initiate an action, if required (e.g., based upon the monitored data). In an embodiment, an action may be triggered or initiated, e.g., based upon a predefined condition, a failure, etc. For example, a self-sustainable object “data filter” may monitor data such as filtering parameter (e.g., name or ID of a row or column of a database table) and when no filtering parameter is provided or when wrong filtering parameter is provided, the self-sustainable object “data filter” may itself send a message to a user to provide correct filtering parameter. Another self-sustainable object “data cluster” may monitor its data such as clustering parameter (e.g., region, day, month, etc.) and when no clustering parameter is provided or wrong clustering parameter is provided, the self-sustainable object “data cluster” may itself send a message to the user to provide correct clustering parameter. Similarly, a self-sustainable object “contract” may monitor its data such as timeframe or validity period (i.e., the period for which the contract is valid) and when the validity period expires, it may itself send a request for quote (RFQ) to the supplier to renew the contract (e.g., to renew itself). Therefore, the self-sustainable object monitors its state or its lifecycle (whether it is active (alive: within validity period) or deactivated (invalid)) and initiates required action to keep itself alive or active. Process step(s) including self-sustainable object(s) may be termed as “self-sustainable process step(s).”

“Internet of Objects” or IoO refers to a network of objects and/or self-sustainable objects communicatively connected to collect and/or exchange data. In an embodiment, the objects or the self-sustainable objects may be communicatively connected to clients, servers, various devices that are on-premise and/or cloud based, to collect and/or exchange data. The IoO enables transfer or exchange of data over a network or among objects or self-sustainable objects without requiring human-to-human interaction. For example, a self-sustainable object “data retrieval” may collect data (e.g., employee attendance database table) from another self-sustainable object “data repository.” Another self-sustainable object “purchase order (PO)” may collect data (e.g., price per product, requested delivery date for which the price quotation is valid, and quantity of the product to be purchased within the specified timeframe, etc.) from another self-sustainable object “purchase requisition (PR).”

“Event” refers to an occurrence of a condition. For example, the occurrence of a condition: “when the target quantity is reached” is an event. The condition may also be formed by a combination of one or more constraints on values of data. For example, a condition including a combination of constraints may be “when the target quantity is reached or exceeded AND/OR the validity period is expired.” The occurrence of these conditions trigger an event. Based upon the event, certain action (e.g., remedial action) may be initiated. For example, an inspection or a repair workflow may be initiated by a self-sustainable object. The remedial action may help to perform predictive maintenance, avoid accidents such as expiration of a contract, keep objects alive, etc. An event may be defined or configured for a self-sustainable object, based upon requirement(s). For example, a self-sustainable object “contract” having data such as price per product (target price), timeframe or validity period, and target quantity may include an event “when the target quantity is reached or exceeded AND/OR the validity period of the contract is expired”, or “if the contract is not used since dd.mm.yy (date format in day, month, year)” based on a requirement. Once any of the conditions is met (event occurred), the contract has to be renewed. The self-sustainable object may trigger or initiate an action (remedial action), based upon the event. For example, when the event “if the contract is not used since dd.mm.yy” is met, the self-sustainable object may initiate contract renewal process or may turn its status to inactive and/or send a request to purchasing department or to a concerned person to provide approval to the self-sustainable object to be deleted, archived, or deactivated. In an embodiment, the self-sustainable object may be configured combining both the event and the remedial action, e.g., “generate RFQ when the target quantity is reached or exceeded AND/OR the validity period of contract is expired.” The object monitors and collects data related to the configured event to determine the occurrence of the event. Based upon the triggered event, the object can initiate the remedial action.

“In-memory” database refers to a database that relies on main memory for computer data storage. In some examples, the in-memory database includes a combination of main memory and disk storage. Also, the in-memory database may implement analytics and transactional processing including replication and aggregation techniques to be performed real-time or near real-time. Also, within the in-memory database environment, calculation logic may be pushed down into the database layer (as opposed to residing in the application layer) such that the processing time for querying and manipulating the data within the database may be reduced as compared with conventional relational databases. In some examples, the in-memory database may be HANA® Enterprise 1.0 (or other versions). However, the techniques described herein may be applied to any type of relational database as well.

Embodiments provide self-sustainable objects within work processes. As explained, self-sustainable objects refer to objects which can monitor themselves, e.g., to determine whether they are functioning properly, getting expired, etc., and based upon a determination, promptly take remedial action(s) if required, e.g., to keep itself active or alive. Thus, the lifecycle or validity of such objects may be enhanced. Further, as self-sustainable object can examine or monitor itself, there is no requirement to develop a separate monitoring application to monitor the object. Further, the object itself can trigger or initiate the required remedial action in case of any failure. Therefore, the self-sustainable object can manage itself. A work process including self-sustainable objects becomes self-sustainable as the included self-sustainable objects can manage themselves. Further, if any change is required within the work process (e.g., addition of a new object, deletion of an object, editing an object, etc.), the object(s) may be added, deleted, or edited without the need to redundantly apply these changes to a separate application (e.g., monitoring application), which saves time and resources. Moreover, as the self-sustainable objects can monitor themselves, the monitoring process may not get interrupted and/or delayed, e.g., due to some bug in the monitoring application. Typically, the monitoring of one object may not be delayed, disturbed, or affected by change(s) in another object. Also, as the self-sustainable objects themselves can initiate recovery action(s) on time, the critical work processes may be performed with less disturbances or delays. Additionally, since self-sustainable objects are self-monitoring, there are potentially fewer management programs that need to be running in the backend consuming processor resources, therefore, the computer itself potentially runs faster with self-monitoring objects. Thus, self-monitoring objects make the computer technically superior.

It may be noted that the work processes described in the below paragraphs are for exemplary purpose and the embodiments may not be restricted to that. The work process may include a number of process steps which may involve one or more self-sustainable objects. Such process steps may be referred to as self-sustainable process steps.

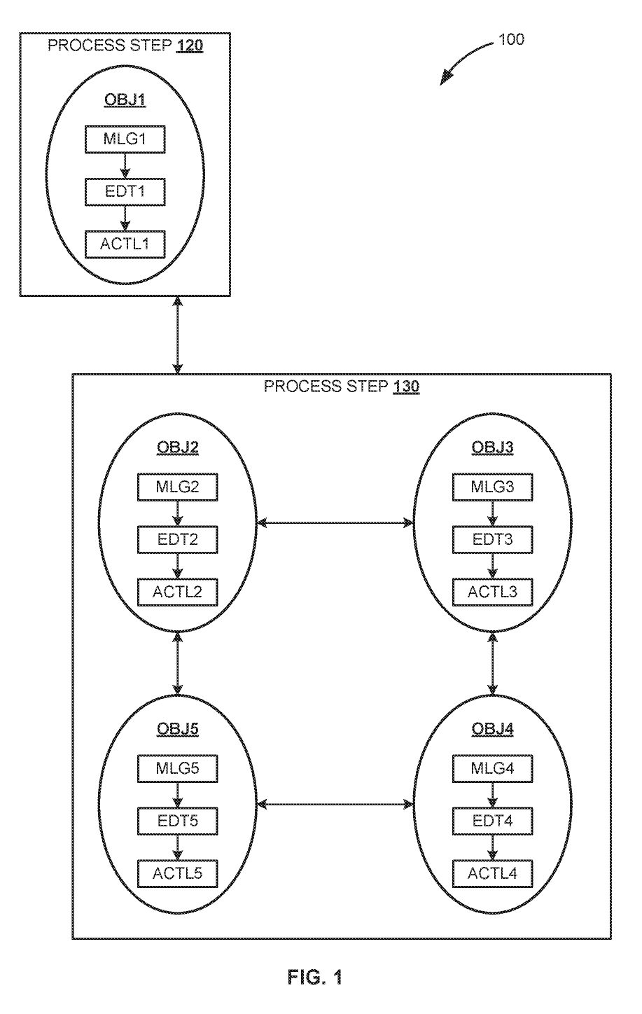

FIG. 1 is a block diagram illustrating exemplary work process 100 comprising self-sustainable process steps 120 and 130 to procure a service and/or product, according to an embodiment. The self-sustainable process steps 120 and 130 include one or more self-sustainable objects. For example, the self-sustainable process step 120 may include self-sustainable object OBJ1 and the self-sustainable process step 130 may include self-sustainable objects OBJ2, OBJ3, OBJ4, and OBJ5. The self-sustainable objects (e.g., OBJ1-OBJ5) may have their respective unique identifiers (ID). The self-sustainable objects (e.g., OBJ1-OBJ5) may have their respective data. The data may include values of various parameters of the self-sustainable object. For example, if the self-sustainable object OBJ1 is “contract”, its respective data may include values of parameters like contract ID, expiry date, validity period, target quantity, target price, etc. The self-sustainable objects (e.g., OBJ1-OBJ5) may be communicatively coupled, e.g., to refer or retrieve data. For example, the object OBJ2 may be “request for quotation (RFQ)” and it may refer to the OBJ1 to read contract data to determine when the contract gets expired. A self-sustainable object (e.g., OBJ1-OBJ5) may be configured to monitor its data and to receive, generate, and/or distribute data. A self-sustainable object may include a monitoring logic to monitor its data. For example, the self-sustainable objects OBJ1-OBJ5 include monitoring logic MLG1-MLG5, respectively, to monitor their data. The monitoring logic MLG1-MLG5 may monitor the data based upon predefined or preconfigured event(s), at a regular time interval or continuously. The self-sustainable objects OBJ1-OBJ5 include event detection logic EDT1-EDT5, respectively, to determine when events occur or are triggered for the corresponding self-sustainable objects OBJ1-OBJ5. In case a predefined event is triggered or detected, the corresponding self-sustainable object (e.g., OBJ1-OBJ5) may initiate required action(s). The self-sustainable objects OBJ1-OBJ5 include action initiating logic ACTL1-ACTL5, respectively, to initiate actions based upon their respective detected events. For example, if the object OBJ1 is “contract” and the predefined event “contract validity date is expired” is triggered, the action initiating logic ACTL1 of the OBJ1 may initiate a contract renewal process.

In an exemplarily embodiment, the work process 100 may be “contract management” including the following self-sustainable process steps:
(i) process step 120 “contract creation”: which is used to create contracts and includes self-sustainable object “contract” (e.g., OBJ1); and
(ii) process step 130 “contract renewal”: which is used to renew contracts and includes self-sustainable objects “request for quote (RFQ)” (e.g., OBJ2); “quote” (e.g., OBJ3); “purchase requisition (PR)” (e.g., OBJ4); and “purchase order (PO)” (e.g., OBJ5).

Self-sustainable object “contract” OBJ1 may include master data related to the contract, e.g., supplier name, product name, product ID, contract ID, and contract details such as timeframe for which the contract is valid or applicable (e.g., validity or contract period), price per product (i.e., price valid within the contract period or target price), and target quantity (quantity of the product to be purchased within the specified timeframe), etc. The “contract” OBJ1 may be referred for buying the product from the supplier or vendor. The OBJ1 monitors itself or it's data to determine if a contract is still valid. The OBJ1 may monitor its data through the monitoring logic MLT1 at regular time intervals, e.g., every day or 24 hrs. Based upon the monitored data, the OBJ1 determines (e.g., through the event detection logic EDT1) whether a predefined event is triggered. The event may be defined to determine the validity of the corresponding contract (e.g., if the validity period has expired, if the purchased product quantity is more than the target quantity, etc.). When the OBJ1 determines that the event is triggered (e.g., through the event detection logic EDT1) indicating invalid contract, the OBJ1 may perform (e.g., using the action initiating logic ACTL1) one or more of, but not limited to: (i) change contract status to inactive; (ii) prepare RFQ and send it to the supplier; (iii) send a message to a user that contract validity has expired; (iv) send a message to purchasing department or concerned person to ask if a new RFQ is to be prepared and upon receiving the approval from the purchasing department or concerned person, prepare the RFQ and send to the supplier; and (v) trigger the process step 120 (e.g., send request to the process step 120) for initiating contract renewal process.

Self-sustainable object “request for quote (RFQ)” OBJ2 creates RFQ and sends it to the supplier. In an embodiment, upon receiving request from the OBJ1 or another object, the OBJ2 prepares the RFQ and sends it to the supplier. In one embodiment, the OBJ2 may itself regularly monitor the validity period or date of a contract (e.g., through the monitoring logic MLG2). In an embodiment, the MLG2 monitors or verifies the validity date of the contract, e.g., from the OBJ1 or from an internal or external data repository maintaining contract data. If it is determined or detected (e.g., through the event detection logic EDT2) that the validity date has expired, the OBJ2 may perform (e.g., using the action initiating logic ACTL2) one or more of, but not limited to: (i) automatically prepare the RFQ and send it to the supplier; (ii) send a message to purchasing department or concerned person about expiry of contract and to inquire if a new RFQ is to be prepared; and (iii) upon receiving the approval from the purchasing department or concerned person, prepares the RFQ and sends to the supplier. In another embodiment, the RFQ could check if the supplier is due to send a quote and trigger a reminder for the supplier.

Self-sustainable object “Quote” OBJ3 represents quotes received from a supplier. Once a quote is received from a supplier, the OBJ3 triggers the OBJ4 to prepare purchase request or requisition based upon the received quote. In an embodiment, the OBJ3 monitors itself, e.g., monitors quote validity date (e.g., through the monitoring logic MLG3). When the monitored quote validity date expires (e.g., detected through the event detection logic EDT3), the OBJ3 may send a message to the purchasing department or the OBJ2 for creating/requesting new quotation from the supplier (e.g., using the action initiating logic ACTL3).

Self-sustainable object “purchase requisition (PR)” OBJ4 prepares purchase requisition (PR), based upon a quote received from a supplier, e.g., through OBJ3. In an embodiment, the OBJ4 may regularly ping OBJ3 (e.g., through the monitoring logic MLG4) to determine if a new quote is received from the supplier. When the new quote is received from the supplier (e.g., detected through the event detection logic EDT4), the OBJ4 may perform (e.g., using the action initiating logic ACTL4) one or more of, but not limited to: (i) send PR to the purchasing department or concerned user to proceed further with PO and purchasing, and (ii) send PR to other object (e.g., OBJ5) to prepare PO corresponding to the PR and proceed with purchasing. In an embodiment, when the OBJ4 sends the PR to the purchasing department or the concerned person, the OBJ4 also triggers the OBJ5 that a new PR is sent to the purchasing department or the concerned person so that the OBJ5 may inquire the purchasing department or the concerned person about preparing PO. In an embodiment, Self-sustainable object “purchase requisition (PR)” OBJ4 prepares purchase requisition (PR) based upon another process like production or maintenance process. A product or service request is triggered or generated by these processes. When the PR is generated, it is determined with MLG4 whether a valid contract exists. The EDT4 may detect whether a contract is already referenced within the PR and whether it may copy the relevant data from the contract (e.g., the OBJ1). When the PR data is completed, the ACTL4 triggers the creation of a PO.

Self-sustainable object “purchase order (PO)” OBJ5 generates POs. In an embodiment, the OBJ5 generates a PO upon receiving a request from at least one of the OBJ4, the purchasing department, and a concerned person. In an embodiment, the OBJ5 may itself regularly monitor (e.g., through the monitoring logic MLG5) the validity date of a contract. The validity date may be monitored, e.g., by referring to the OBJ1 or an internal or external data repository maintaining the contract data. When the validity date expires (e.g., detected through the event detection logic EDT5), the OBJ5 may inquire (e.g., using the action initiating logic ACTL5) the purchasing department or the concerned person whether the PO is to be generated, e.g., even if the contract is not valid. In an embodiment, the OBJ5 inquires the purchasing department or the concerned person, e.g., when triggered by the OBJ4 or by monitoring OBJ4 and detecting that new PR is generated by the OBJ4. Upon receiving approval for generating PO, the OBJ5 generates the PO, e.g., by reading PR information from the OBJ4. The PO may include the official purchase order with product, price, quantity and delivery date. The OBJ5 sends the PO to the supplier. The PO is the basis for the delivery and invoice. In an embodiment, upon receiving the triggering (e.g., receiving a message) from the OBJ4 about the new PR, the OBJ5 generates the PO corresponding to the new PR and sends it to the supplier. In an embodiment, once the PO is generated, the OBJ5 may trigger the OBJ1 “contract” to update its data. In another embodiment, the OBJ1 may regularly monitor or request the OBJ5 for the PO data, and update its data accordingly. In an embodiment, if no contract is existing to procure a product or service, the OBJ5 could determine if there are other POs without an existing contract reference and initiate to create a contract for procurement of this product or service e.g. by triggering an RFQ.

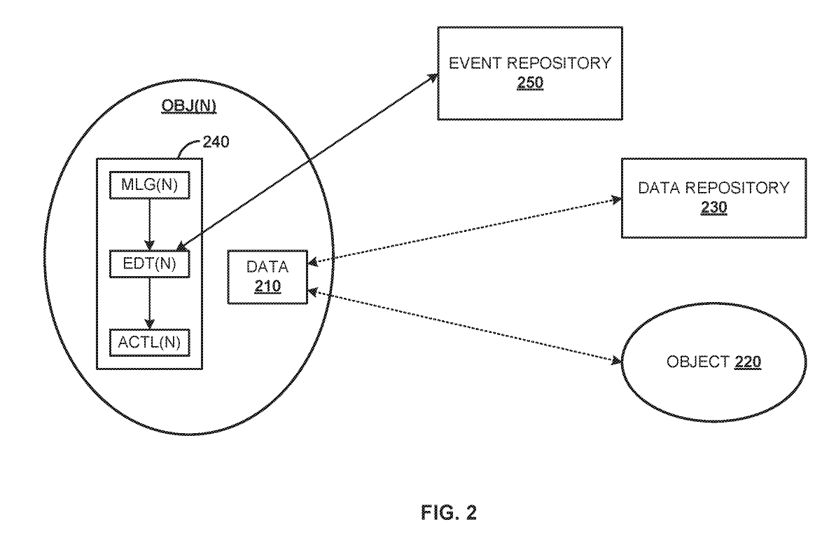

FIG. 2 illustrates generic structure of a self-sustainable object OBJ(N), according to an embodiment. The OBJ(N) includes data 210 which may be values of various parameters related to the OBJ(N). The data 210 may also describe current state of OBJ(N), e.g., whether its active (valid), expired, etc. For example, if the OBJ(N) is a “contract” then data may be value of contract ID, expiry date, validity period, target quantity, price per item, status, etc. The data 210 may be updated, e.g., from quote, in real-time or at a predefined time interval. For example, data related to object “plane tracking” may be updated in real-time whereas data related to object “contract” may be updated at a predefined time interval, e.g., when the contract gets expired and a new contract is created. The OBJ(N) may itself update the data 210. For example, if the OBJ(N) comprises “contract” it may update the data 210 based upon new “quote” received from the supplier. The OBJ(N) may update the data 210 by referring to another object or by receiving updated data from a user or another object. For example, the OBJ(N) may update the data 210 by referring to another object 220. In an embodiment, the data 210 may be a part of the OBJ(N). In another embodiment, the data 210 may be maintained in an external data repository 230 and the OBJ(N) refers to the external data repository 230 to read or retrieve the data 210. The OBJ(N) further includes object logic 240. The object logic 240 comprises logic which makes the OBJ(N) self-sustainable. For example, the object logic 240 may include monitoring logic MLG(N) to enable OBJ(N) to monitor itself or its data 210. The data 210 may be monitored, e.g., to determine status (e.g., active, inactive, alive, etc.) of the OBJ(N). The data 210 may be monitored continuously in real time or at a predefined time interval. The object logic 240 further includes event detection logic EDT(N) to detect or determine whether any predefined event is triggered, e.g., based upon the monitored data. The event detection logic EDT(N) may detect event by referring to one or more predefined events stored in event repository 250. In an embodiment, the event detection logic EDT(N) may include the predefined event(s). In another embodiment, the predefined events for the OBJ(N) may be stored or maintained in the event repository 250 and the event detection logic EDT(N) may refer to the event repository 250 to determine if the event is triggered, based upon the monitored data. The object logic 240 also includes action initiating logic ACTL(N) to initiate one or more actions (e.g., recovery action), when the event is triggered.

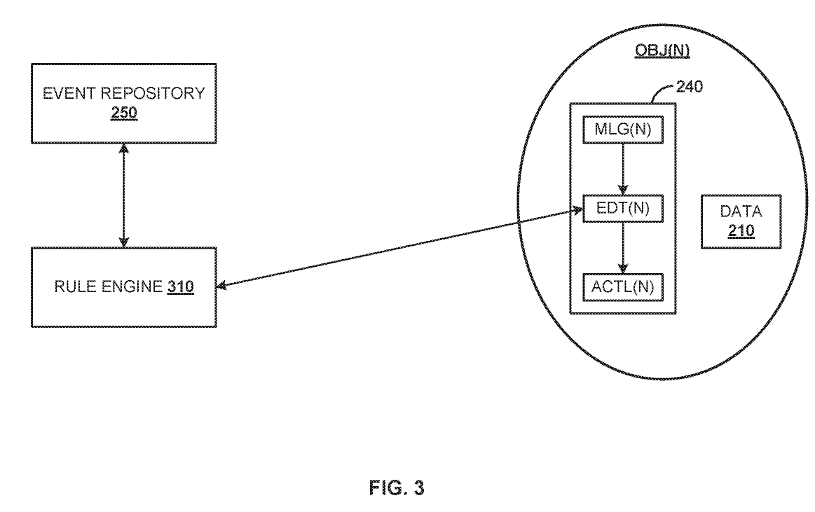

The events for self-sustainable objects may be defined or updated through rule engine. The events may be defined or updated during design-time (e.g., while defining the object) and/or runtime (e.g., when the work process is executed). FIG. 3 illustrates an exemplarily rule engine 310 connected to object logic (e.g., the object logic 240 of FIG. 2) of self-sustainable object (e.g., the self-sustainable object OBJ(N) of FIG. 2) to define or update events for the self-sustainable object, according to an embodiment. The rule engine 310 refers to a software component where rules and events within the object logic of the self-sustainable object (e.g., the object logic 240 the object OBJ(N)) can be defined, included, or changed. In an embodiment, when the rules and events are maintained separately from the object logic (e.g., within the external event repository 250), the rule engine 310 may be connected to the event repository 250 so that the events/rules may be included or updated directly within the event repository 250. The rules or events may be updated or included, through the rule engine 310, e.g., during runtime. In an embodiment, the rule engine 310 may be connected to object-defining engine (not shown) to define or update rules or events for the self-sustainable object, e.g., during design time.

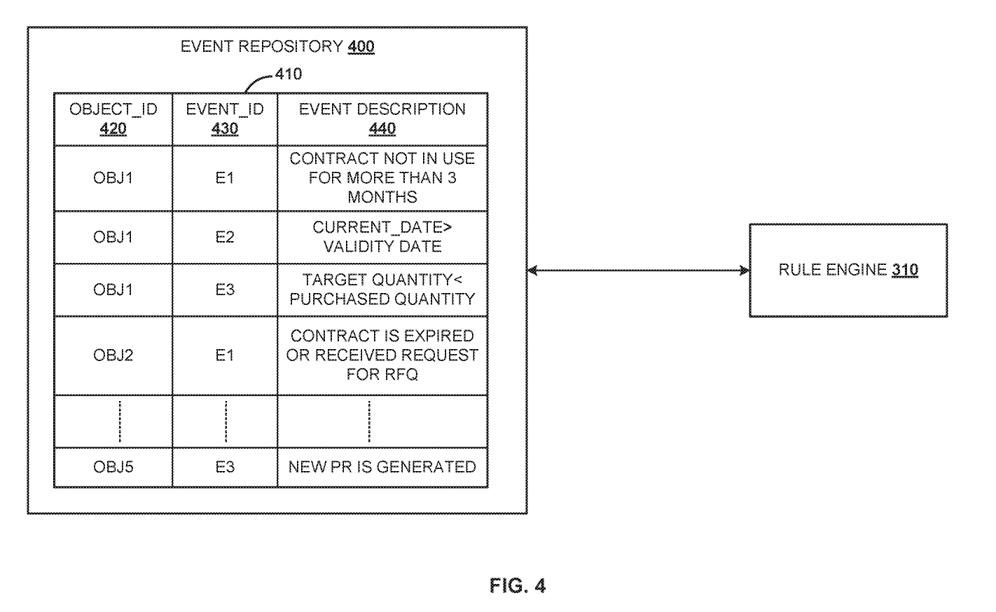

In an embodiment, there may be a central event repository for maintaining events and rules related to all the self-sustainable objects of a work process. FIG. 4 illustrates an exemplary event repository 400 including event table 410 for storing various events defined for the self-sustainable objects (e.g., OBJ1-OBJ5 of the work process 100 of FIG. 1), according to an embodiment. The event table 410 includes fields, but are not limited to: (i) object_ID 420 which identify object for which the event is defined, (ii) event_ID 430 which identify a name or an ID of an event defined for an object, and (iii) event description 440 which describes the event. As shown in FIG. 4, three events E1-E3 may be defined for the object OBJ1, one event E1 may be defined for the object OBJ2, etc. The event repository 400 may be connected to the rule engine 310 so that new event(s) may be defined or existing event(s) may be updated for an object through the rule engine 310. The new event(s) may be defined or existing event(s) may be updated through the rule engine 310 during the design time or runtime. In an embodiment, a command may be entered through the rule engine 310 to define or update an event directly within the event repository 400. For example, to edit or update the event E1 of OBJ1 (i.e., “CONTRACT NOT IN USE FOR MORE THAN 3 MONTHS”, as shown in FIG. 4), a command “update E1 of OBJ1 with <CONTRACT NOT IN USE FOR MORE THAN 2 MONTHS>” may be entered to update 3 months to 2 months. Based upon the updated event E1 of OBJ1, the event would be triggered when the contract is not used for more than 2 months. Similarly, a new event (e.g., E2) may be defined for OBJ2 by entering a command through the rule engine 310 to trigger an event for OBJ2 when “current date is more than validity date of the contract”. The command may be entered as: “include E2 for OBJ2 as <CURRENT_DATE≥VALIDITY_DATE>”. When a new event is defined for the self-sustainable object (e.g., new event E2 defined for the object OBJ2) in the event repository 400, the corresponding action initiating logic of the self-sustainable object (e.g., the action initiating logic ACTL2 of the OBJ2 as shown in FIG. 1) may be updated to define the action(s) to be performed when the new event is triggered. In an embodiment, the action initiating logic of the self-sustainable object, e.g., ACTL2 of the OBJ2, may be updated through the rule engine 310 itself.

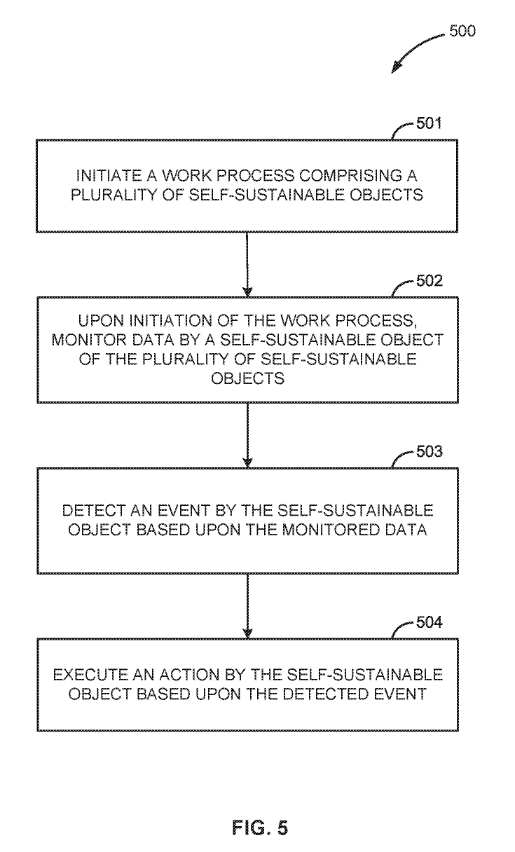

FIG. 5 is a flowchart illustrating process 500 to execute work process through self-sustainable objects, according to an embodiment. At 501, a work process (e.g., the work process 100 of FIG. 1) comprising a plurality of self-sustainable objects (e.g., the self-sustainable objects OBJ1-OBJ5 of FIG. 1) is initiated. In an embodiment, initiating the work process refers to starting the work process for execution. In an embodiment, when a user triggers a ‘start button or icon,’ the work process may be initiated. The work process (e.g., the work process 100 of FIG. 1) includes a plurality of self-sustainable objects (e.g., the self-sustainable objects OBJ1-OBJ5 of FIG. 1). A self-sustainable object includes data representing values of one or more attributes of the self-sustainable object. For example, if the object is a “contract,” its data may be values of attributes like, supplier name, contract ID, validity period, target quantity, etc. In an embodiment, the data may be maintained within the self-sustainable object. In another embodiment, the data may be maintained in an external data repository (e.g., the data repository 230 of FIG. 2) communicatively coupled to the self-sustainable object. At 502, once the work process is initiated, the self-sustainable object monitors its data. In an embodiment, the data may be monitored by the self-sustainable object either in real time (e.g., data of objects relating to flight tracking) or at a predefined time interval (e.g., data of objects relating to machine maintenance, contract renewal, etc.). At 503, an event is detected by the self-sustainable object based upon the monitored data. The event may be an occurrence of a condition, e.g., indicating some error, failure, or other critical situations. One or more events may be predefined for the self-sustainable object. At 504, based upon the detected event, an action is executed by the self-sustainable object. The action may be at least one of sending a message to another self-sustainable object (e.g., if contract is expired as indicated by the event, a message is sent to another object to generate the RFQ), sending a request to a user (e.g., notifying about failure and asking approval to proceed with the repair action), initiating a repair action (in case of any failure), and updating statuses of the self-sustainable object. The status of the self-sustainable object may be one of an active state, an inactive state (expired), etc. In an embodiment, the self-sustainable object requires user's input (e.g., approval or rejection to execute certain process such as repair process). A request for user's input is received from the self-sustainable object and the requested user's input is sent to the self-sustainable object for executing the work process.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs. DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java. C++, or other object-oriented programming language and development tools. Another embodiment may be implemented in hard-wired circuitry in place of, or in combination with machine readable software instructions.

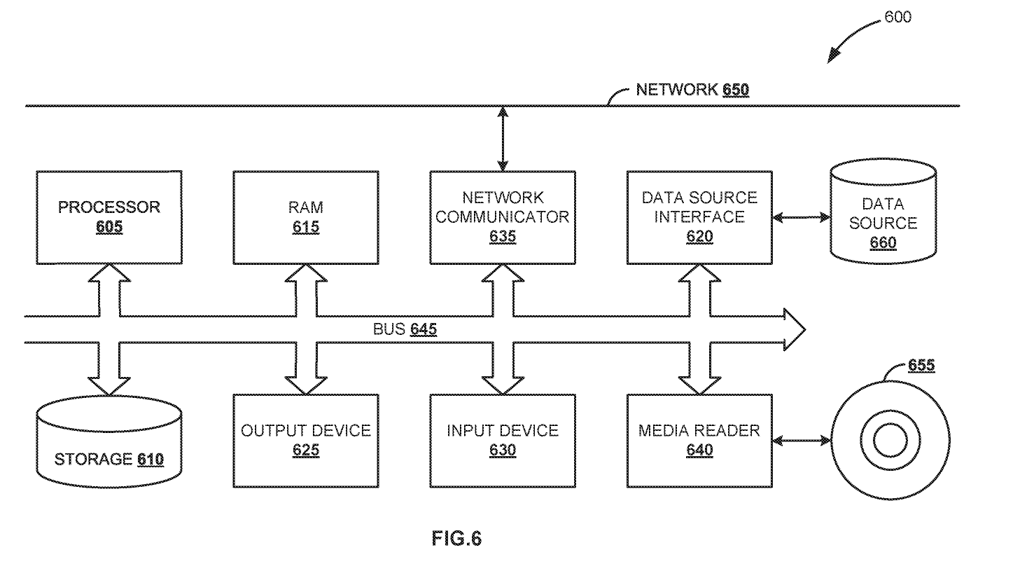

FIG. 6 is a block diagram of an exemplary computer system 600. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. The output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer-readable medium to store instructions, which when executed by a computer, causes the computer to perform operations comprising:
initiating a work process comprising a plurality of self-sustainable objects;
upon initiation of the work process, monitoring data by a self-sustainable object of the plurality of self-sustainable objects, wherein the data represents values of one or more attributes of the self-sustainable object;
based upon the monitored data, detecting an event by the self-sustainable object; and
based upon the detected event, executing an action by the self-sustainable object.

2. The non-transitory computer readable medium of claim 1, wherein initiating the work process refers to starting the work process for execution.

3. The non-transitory computer readable medium of claim 1, wherein the data is monitored by the self-sustainable object in one of:
a real time; and
at a predefined time interval.

4. The non-transitory computer readable medium of claim 1, wherein the event is an occurrence of a condition defined through a rule engine and wherein the event is predefined for the self-sustainable object.

5. The non-transitory computer readable medium of claim 1, wherein the event is defined within one of:
the self-sustainable object; and
an event repository communicatively coupled to the self-sustainable object.

6. The non-transitory computer readable medium of claim 5, wherein the event repository includes an event table comprising events defined for the plurality of self-sustainable objects of the work process.

7. The non-transitory computer readable medium of claim 1, wherein the event is updated during a runtime through a rule engine.

8. The non-transitory computer readable medium of claim 1, wherein the action comprises at least one of:
sending a message to another self-sustainable object of the plurality of self-sustainable objects;
sending a request to a user;
initiating a repair action; and
updating statues of the self-sustainable object, wherein status comprises one of an active state, an inactive state, and getting expired.

9. The non-transitory computer readable medium of claim 1, wherein the data includes a current state of the self-sustainable object and wherein:
the event is detected when the current state of the self-sustainable object is an inactive state; and
the action is executed to convert the current state of the self-sustainable object from the inactive state to an active state.

10. The non-transitory computer readable medium of claim 1, wherein the action includes:
sending a request for user input, wherein the user input comprises one of an approval and a rejection; and
executing the work process based upon the user's input.

11. A computer-implemented method comprising:
initiating a work process comprising a plurality of self-sustainable objects;
upon initiation of the work process, monitoring data by a self-sustainable object of the plurality of self-sustainable objects, wherein the data represents values of one or more attributes of the self-sustainable object;
based upon the monitored data, detecting an event by the self-sustainable object; and
based upon the detected event, executing an action by the self-sustainable object.

12. The method of claim 11, wherein the action comprises at least one of:
sending a message to another self-sustainable object of the plurality of self-sustainable objects;
sending a request to a user;
initiating a repair action; and
updating statues of the self-sustainable object, wherein status comprises one of an active state, an inactive state, and getting expired.

13. A computer system comprising:
at least one memory to store executable instructions; and
at least one processor communicatively coupled to the at least one memory, the at least one processor configured to execute the executable instructions to:
initiate a work process comprising a plurality of self-sustainable objects;
upon initiation of the work process, monitor data by a self-sustainable object of the plurality of self-sustainable objects, wherein the data represents values of one or more attributes of the self-sustainable object;
based upon the monitored data, detect an event by the self-sustainable object; and
based upon the detected event, execute an action by the self-sustainable object.

14. The system of claim 13, wherein the self-sustainable object monitors the data in one of:
a real time; and
at a predefined time interval; and
an event triggered by another object.

15. The system of claim 13, wherein the event is defined within one of:
the self-sustainable object; and
an event repository communicatively coupled to the self-sustainable object.

16. The system of claim 15, wherein the event repository includes an event table comprising events defined for the plurality of self-sustainable objects of the work process.

17. The system of claim 13, wherein the event is updated during a runtime through a rule engine.

18. The system of claim 13, wherein the action includes:
sending a request for user input, wherein the user input comprises one of an approval and a rejection; and
executing the work process based upon the user's input.

19. The system of claim 13, wherein the action comprises at least one of:
sending a message to another self-sustainable object of the plurality of self-sustainable objects;
sending a request to a user;
initiating a repair action; and
updating statues of the self-sustainable object, wherein status comprises one of an active state, an inactive state, and getting expired.

20. The system of claim 13, wherein the data includes a current state of the self-sustainable object and wherein:
the event is detected when the current state of the self-sustainable object is an inactive state; and
the action is executed to convert the current state of the self-sustainable object from the inactive state to an active state.
